(19) United States
(12) Patent Application Publication
(10) Pub. No.: US 2012/0148846 A1
(43) Pub. Date: Jun. 14, 2012

(54) COLOR PLUS CLEAR COATING SYSTEMS EXHIBITING DESIRABLE APPEARANCE AND FINGERPRINT RESISTANCE PROPERTIES AND RELATED METHODS

(75) Inventors: David C. Martin, Bethel Park, PA (US); Brian K. Rearick, Allison Park, PA (US); Kurt A. Humbert, Pittsburgh, PA (US); Xiangling Xu, Pittsburgh, PA (US); Noel R. Vanier, Wexford, PA (US)

(73) Assignee: PPG Industries Ohio, Inc., Cleveland, OH (US)

(21) Appl. No.: 12/964,822

(22) Filed: Dec. 10, 2010

(51) Int. Cl. B32B 27/08; B05D 1/36

(52) U.S. Cl. 428/411.1; 427/407.1

(57) ABSTRACT

Disclosed are methods of forming a multi-component composite coating on a substrate. The methods include applying a transparent radiation curable film-forming composition onto a colored base coat deposited upon a substrate to form a transparent top coat over the basecoat. The colored base coat includes a colorant and a film-forming resin, and the transparent radiation curable film-forming composition includes a fluorine-containing radiation curable compound.

### FIELD OF THE INVENTION

The present invention is directed to color plus clear coating systems that exhibit desirable appearance and fingerprint resistance properties.

### BACKGROUND OF THE INVENTION

Color-plus-clear composite coating systems involving the application of a colored or pigmented base coat to a substrate followed by application of a transparent topcoat to the base coat are often desired because they can have very desirable appearance properties, such as outstanding gloss and distinctness of image, due in large part to the clear coat.

In some applications, such as when a coating is to be applied to an article that is often handled by a person, such as a consumer electronics device, including laptop computers, personal data assistants, cellular telephones, and the like, it may be desirable to have a coating that is resistant to fingerprint stains. As such, it is often desirable that such coatings exhibit oleophobicity (incompatibility with nonaqueous organic substances).

In addition, many substrate materials used in the production of the foregoing articles, such as plastics, can be sensitive to the application of heat. Therefore, coating compositions that require heat to cure may not be suitable. For this reason, as well as environmental advantages and reduced energy usage, it may be desirable to employ radiation curable coatings, such as those cured by exposure to ultraviolet (“UV”) radiation, in such applications, especially when the coating composition is transparent to such radiation, such as is the case with transparent topcoats.

As a result, it would be desirable to provide color-plus-clear composite coating systems that exhibit desirable appearance, such as outstanding gloss and distinctness of image, as well as resistance to fingerprint stains, while employing a radiation curable transparent top coat.

### SUMMARY OF THE INVENTION

In certain respects, the present invention is directed to methods of forming a multi-component composite coating on a substrate. The methods comprise applying a transparent radiation curable film-forming composition onto a colored base coat deposited upon a substrate to form a transparent top coat over the basecoat, wherein: (a) the colored base coat comprises: (i) a colorant, and (ii) a film-forming resin, and (b) the transparent radiation curable film-forming composition comprises a fluorine-containing radiation curable compound.

In other respects, the present invention is directed to multi-component composite coatings comprising a colored coating serving as a base coat and a transparent topcoat over the base coat, wherein the transparent topcoat is a radiation cured composition comprising a fluorine-containing radiation cured compound.

The present invention is also directed to, for example, related coated substrates.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, certain embodiments of the present invention are directed to methods of forming a multi-component composite coating on a substrate. The methods comprise applying a transparent radiation curable film-forming composition onto a colored base coat deposited upon a substrate. The colored base coat is formed from a colored film-forming composition.

The colored film-forming composition that forms the colored base coat comprises any film-forming resin useful for forming a coating. Suitable film-forming resins include any of a variety of thermoplastic and/or thermosetting compositions known in the art. Such coating composition(s) may be water-based or solvent-based liquid compositions, or, alternatively, in solid particulate form, i.e., a powder coating.

Thermosetting coating compositions often comprise a crosslinking agent that may be selected from, for example, aminoplasts, polyisocyanates including blocked isocyanates, polyepoxides, beta-hydroxyalkylamides, polyacids, anhydrides, organometallic acid-functional materials, polyamines, polyamides, and mixtures of any of the foregoing.

In addition to or in lieu of the above-described crosslinking agents, such coating compositions often comprise a film-forming resin that may be selected from any of a variety of polymers well-known in the art, including, for example, acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art. Such polymers may be solvent borne or water dispersible, emulsifiable, or of limited water solubility and often have functional groups that are reactive with a crosslinking agent, if such a crosslinking agent is present. Exemplary such functional groups include, without limitation, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

Appropriate mixtures of film-forming resins may also be used in the preparation of such coating compositions.

The colored film-forming composition that forms the colored base coat in the methods of the present invention comprises a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, salt type (flakes), benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, peryleneand quinacridone.

Example metal pigments include aluminum powder, copper powder, bronze powder, zinc dust, aluminum flakes, nickel flakes, copper flakes, bronze flakes, brass flakes, and chromium flakes.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

If desired, the colored film-forming compositions that forms the colored base coat in the methods of the present invention coating composition can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, fillers, organic cosolvents, catalysts, including phosphonic acids and other customary auxiliaries.

In certain embodiments, the colored film-forming composition that forms the colored base coat in the methods of the present invention comprises one or more additives for improving the appearance of the color-plus-clear coating system. For example, in certain embodiments, the colored film-forming composition that forms the colored base coat in the methods of the present invention comprises a cellulose ester additives, such as cellulose acetate (CA), cellulose acetate propionate (CAP), and/or cellulose acetate butyrate (CAB). Such additives can improve the appearance of the color-plus-clear coating system by improving the flow and leveling of the colored film-forming composition and improving metal flake orientation if such flakes are present in the colored film-forming composition to provide a “metallic” look, as is sometimes desirable. Moreover, such additives can improve the appearance of the color-plus-clear coating system by promoting fast drying and early hardness development of the colored film-forming composition, thereby helping to reduce intermixing (i.e., increasing “hold out”) of the subsequently applied transparent radiation curable film-forming composition described herein.

In general, the cellulose ester additives can be present in any amount sufficient to impart the desired coating properties. For example, such additives may comprise from 0.5 to 10 weight percent of the colored film-forming composition, with weight percent based on the total solids weight of the compositions.

In addition, in certain embodiments, the colored film-forming composition comprises a silicone to, for example, assist in substrate wetting. Suitable silicones include various organosiloxanes such as polydimethylsiloxane, polymethylphenylsiloxane and the like. Specific examples of such include SF-1023 silicone (a polymethylphenylsiloxane available from General Electric Co.), AF-70 silicone (a polydimethylsiloxane available from General Electric Co.), and DF-100 S silicone (a polydimethylsiloxane available from BASF Corp.), as well as BAYSILONE 067 and BAYSILONE OL17, commercially available from Bayer Corporation. If employed, such silicones are typically added to the colored film-forming composition in an amount ranging from 0.01 to 1.0 percent by weight based on total resin solids in the coating composition. In fact, a surprising discovery of the present invention was that use of a colored film-forming composition comprising such a silicone based flow additive, while providing the substrate wetting properties described above, did not adversely effect the fingerprint resistance properties of the subsequently applied transparent radiation curable film-forming composition described herein. This was surprising because these additives are designed to migrate to the coating surface and they are known to prevent the formation of an oleophobic surface.

In certain embodiments, the colored film-forming composition may further comprise a component that acts to improve the intercoat adhesion between the colored film-forming composition and the transparent radiation-curable composition or otherwise improve the appearance of the color-plus-clear coating system. For example, and without limitation, in some embodiments it may be desirable to include a crosslinking agent, such as any of those described earlier, in the colored film-forming composition even when the colored film-forming composition is not a thermosetting composition. In these cases, the crosslinking agent may have functionality reactive with functional groups present in the radiation-curable compound(s) present in the transparent radiation-curable composition. The presence of such a crosslinker in the thermoplastic colored film-forming composition may, for example, act to reduce the cure rate differential between the two coating composition and provide interlayer crosslinking.

Moreover, in certain embodiments, the colored film-forming composition comprises an initiator, such as a free radical initiator. Free radical initiators are commercially available from, for example, Ciba Specialty Chemicals Corporation under the tradenames DURACURE and IRGACURE, including for example DURACURE 4265 and IRGACURE 184 initiators; EM Industries, including for example, EM 1173 initiator; Rahn U.S.A. Corporation under the tradename GENOCURE, including for example GENOCURE MBF initiator; and DuPont under the tradename VAZO, including for example, VAZO 67 and VAZO 88 initiators. In certain embodiments, the initiator is present in the colored film-forming composition in an amount ranging from 0.01 to 5 percent by weight, such as from 0.1 to 1.0 percent by weight, based on the total weight of the first coating composition. The inclusion of such an initiator in the colored film-forming composition, may act to, for example, improve the intercoat adhesion of the color-plus-clear coating systems systems described herein. It is believed that the presence of an initiator in the colored film-forming composition may promote the polymerization of certain radiation curable compounds that migrate from the transparent radiation curable film-forming composition to the colored film-forming composition.

In certain embodiments of the methods of the present invention, the basecoat formed from the colored film-forming composition is opaque. As used herein, “opaque” means that the coating hides the underlying surface when viewed with the naked eye.

As previously indicated, the methods of the present invention comprise applying onto the base coat a transparent radiation curable film-forming composition to form a transparent top coat over the base coat. As used herein, “transparent” means a coating that is not opaque, that is, the coating does not hide an underlying surface when viewed with the naked eye. Such transparent coatings can be colorless or colored.

As used herein, a “radiation curable film-forming composition” refers to a composition that includes a radiation curable compound. As used herein, a “radiation-curable compound” refers to any compound that, when exposed to radiation, will undergo crosslinking with itself and/or another radiation-curable compound. Often, such compounds comprise a “radiation-curable moiety” through which radiation cure occurs. Such moieties may, for example, comprise C═CH₂ functionality. These compounds may further comprise a second functionality such as hydroxy, thiol, primary amines and/or secondary amines, among others.

In certain embodiments, the radiation-curable compound comprises a (meth)acrylic polymer or copolymer. As used herein, “(meth)acrylic” and like terms refers both to the acrylic and the corresponding methacrylic. Suitable (meth)acrylic polymers include (meth)acrylic functional (meth)acrylic copolymers, epoxy resin (meth)acrylates, polyester (meth)acrylates, polyether (meth)acrylates, polyurethane (meth)acrylates, amino (meth)acrylates, silicone (meth)acrylates, and melamine (meth)acrylates. The number average molecular weight (“Mn”) of these compounds can range from 200 to 10,000, such as 1200 to 3000. These compounds can contain any number of olefinic double bonds that allow the compound to be polymerized upon exposure to radiation; in certain embodiments, the compounds have an olefinic equivalent weight of 500 to 2000. The (meth)acrylic polymers can be (cyclo)aliphatic and/or aromatic.

In certain embodiments, the (meth)acrylic copolymer comprises a urethane linkage, and in certain other embodiments can comprise a urethane linkage, a terminal acrylate group, and a hydroxy group. Specific examples of polyurethane (meth)acrylates are reaction products of a polyisocyanate such as 1,6-hexamethylene diisocyanate and/or isophorone diisocyanate, including isocyanurate and biuret derivatives thereof, with hydroxyalkyl (meth) acrylate such as hydroxyethyl (meth)acrylate and/or hydroxypropyl (meth)acrylate. The polyisocyanate can be reacted with the hydroxyalkyl (meth)acrylate in a 1:1 equivalent ratio or can be reacted with an NCO/OH equivalent ratio greater than 1 to form an NCO-containing reaction product that can then be chain extended with a polyol such as a diol or triol, for example 1,4-butane diol, 1,6-hexane diol and/or trimethylol propane. Examples of polyester (meth)acrylates are the reaction products of a (meth)acrylic acid or anhydride with a polyol, such as diols, triols and tetraols, including alkylated polyols, such as propoxylated diols and triols. Examples of polyols include 1,4-butane diol, 1,6-hexane diol, neopentyl glycol, trimethylol propane, isosorbide, pentaerythritol and propoxylated 1,6-hexane diol.

In certain embodiments, such polymer(s) are present in the radiation curable composition in an amount ranging from 10 to 90 percent by weight, such as from 10 to 50, or, in some cases, 20 to 40 percent weight, based on the total weight of the first radiation curable composition.

The radiation curable coating composition may further comprise at least one multi-functional (meth)acrylate monomers, which refers to monomers having a (meth)acrylate functionality of greater than 1.0, such as at least 2.0. Multifunctional acrylates suitable for use in the compositions of the present disclosure include, for example, those that have a relative molar mass of from 170 to 5000 grams per mole, such as 170 to 1500 grams per mole. In the compositions of the present disclosure, the multifunctional acrylate may act as a reactive diluent that is radiation curable. Upon exposure to radiation, a radical induced polymerization of the multi-functional (meth)acrylate with monomer is induced, thereby incorporating the reactive diluent into the coating matrix.

Multi-functional (meth)acrylates suitable for use in the radiation curable compositions of the present disclosure may include, without limitation, difunctional, trifunctional, tetrafunctional, pentafunctional, hexafunctional (meth)acrylates and mixtures thereof.

Representative examples of suitable multi-functional (meth)acrylates include, without limitation, ethylene glycol di(meth)acrylate, 1,3-butylene glycol di(meth)acrylate, 1,4-butanediol diacrylate, 2,3-dimethylpropane 1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethyleneglycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate, including mixtures thereof.

In certain embodiments, the multifunctional (meth)acrylate monomer is present in the radiation curable composition in an amount ranging from 1 to 30 percent by weight, such as from 1 to 20, or, in some cases, 5 to 15 percent weight, based on the total weight of the radiation curable film-forming composition.

As previously indicated, in the present invention, the transparent radiation curable film-forming composition comprises a fluorine-containing radiation curable compound. A suitable class of such compounds can be represented by the general formula (I):

(R_{A})ₓ—W—(R_{f})_{y} (I)

wherein: (i) each R_{A} independently represents a radiation curable moiety, such as a moiety comprising a (meth)acrylate group, each R_{f} independently represents a fluorinated moiety, x is at least 2, such as from 2 to 5; y is at least 1, such as 1 to 5; and W is a group linking R_{A} and R_{f}. Some examples of fluorine-containing radiation curable compounds that are suitable for use in the present invention are described in U.S. Pat. No. 6,238,798 at col. 4, line 21 to col. 7, line 34, the cited portion of which being incorporated herein by reference.

In some embodiments, the fluorine-containing radiation curable compound comprises a perfluoro-type polymer. As used herein, a perfluoro-type polymer refers to a polymer in which most of or all of hydrogen of alkyl groups and/or alkylene groups in the polymer are substituted with a fluorine. As used herein, a polymer in which 85% or more of hydrogen of alkyl groups and/or alkylene groups are substituted with a fluorine, is defined as a perfluoro-type polymer.

In certain embodiments, the fluorine-containing radiation curable compound comprises a perfluoropolyether (PFPE) and one or more, often two or more, polymerizable unsaturated groups, such as (meth)acrylate groups, per molecule. Fluorine-containing radiation curable compounds can be derived from, for example, a polyisocyanate, such as a triisocyanate, reacted with a hydroxyl-functional fluoropolymer and a hydroxyl-functional (meth)acrylate. Thus, in certain embodiments, the fluorine-containing radiation curable compound of structure (I) is represented by the general structure (Ia).

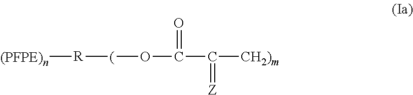

in which: (a) each n and m is independently 1 or 2 (in some embodiments m+n=3); (b) R is a linking group (in some embodiments R comprises one or more urethane linkages); and (c) Z is H or CH₃.

One example of a commercially available fluorine-containing radiation curable compound of this type is Optool DAC, manufactured by Daikin Industries, Ltd., which is believed to have the structure (Ib).

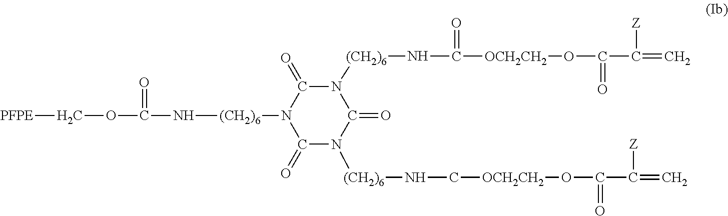

in which Z is H or CH₃ and PFPE has the structure:

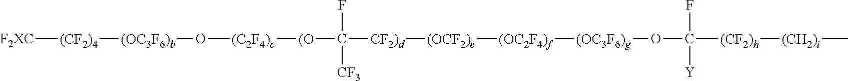

wherein: X and Y are each independently F or CF₃; a is an integer in the range of 1 to 16; b, d, e, f and g are each independently an integer in the range of 0 to 200; c is an integer in the range of 0 to 5; and h and I are each independently an integer in the range of 0 to 16. Another example is a compound having the following structure:

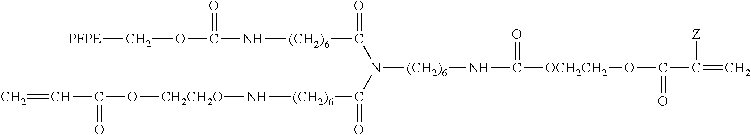

In certain embodiments, the weight average molecular weight of the fluorine-containing radiation curable compound is from 400 to 40,000, such as 400 to 5000, or, in some cases, 800 to 4000 or 1000 to 3000.

Further, in some embodiments of the present invention the fluorine-containing radiation curable compound comprises a compound represented by the following formula (II).

(Rf¹)—[W)—(R_{A})ₙ]ₘ (II)

wherein: Rf¹ represents a (per)fluoroalkyl group or a (per)fluoropolyether group; W represents a single bond or a linking group; R_{SA}) represents a functional group having an unsaturated double bond; n represents an integer of 1 to 3, such as 2 to 3; and m represents an integer of 1 to 3, such as 2 to 3.

In formula (II), W represents, for example, alkylene, arylene, heteroalkylene, or a combined linking group thereof. These may further contain each of the structures such as carbonyl, carbonyloxy, carbonylimino, urethane, ester, amide, sulfoneamide, and the like, and a linking group having a combined structure thereof.

In formula (II), R_{(A)} may comprise, for example:

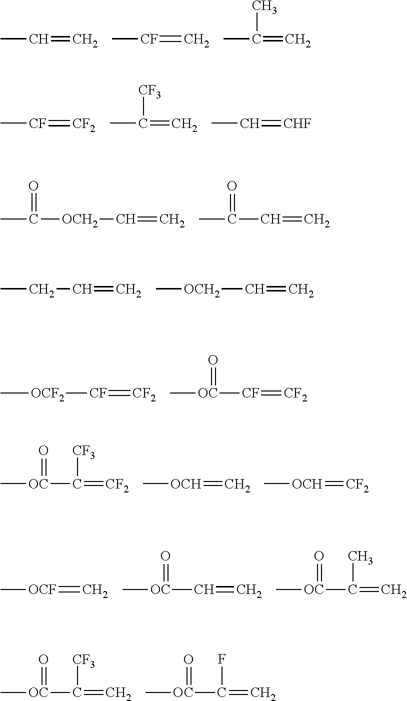

In some embodiments, n and m in formula (II) are both 1, specific examples of which include compounds represented by the formulae (III), (IV) and (V).

Rf¹¹(CF₂CF₂)ₙCH₂CH₂—(W)—OCOCR¹═CH₂ (III)

F(CF₂)ₚ—CH₂—CHX—CH₂Y (IV)

F(CF₂)ₙO(CF₂CF₂O)ₘCF₂CH₂OCOCR═CH₂ (V)

In formula (III), Rf¹¹ represents at least one of fluorine atom and a fluoroalkyl group having 1 to 10 carbon atoms; R¹ represents a hydrogen atom or a methyl group; W represents a single bond or a linking group; n represents an integer of no less than 2.

In formula (IV), p is an integer of 1 to 20, such as 6 to 20 or 8 to 10, and X and Y are either a (meth)acryloyloxy group or a hydroxyl group, and at least one thereof is a (meth)acryloyloxy group.

In the formula (V), R is a hydrogen atom or a methyl group, m is an integer of 1 to 20, and n represents an integer of 1 to 4. Such compounds can be obtained by reacting a (meth)acrylic acid halide with a fluorine atom-containing alcohol compound represented by the following formula (VI):

F(CF₍₂₎)₍ₙ₎O(CF₍₂₎CF₍₂₎O)₍ₘ₎CF₍₂₎CH₍₂₎OH (VI)

wherein m represents an integer of 1 to 20 and n represents an integer of 1 to 4.

In certain embodiments, the fluorine-containing radiation curable compound comprises a compound represented by the following formula (VII).

Rf¹²—[(O)_{c}(OC)_{b}(CX⁴X⁵)ₐ—CX³CX¹X²]_{d} (VII)

wherein X¹ and X² each independently represents H or F; X³ represents H, F, CH₃, or CF₃; X⁴ and X⁵ each independently represents H, F, or CF₃; a, b, and c each independently represents 0 or 1; d represents an integer of 1 to 4; Rf¹² represents a group having an ether bond having 18 to 200 carbon atoms and has 6 or more, such as 6.5 to 8, 10 or more, 18 to 22, or, in some cases, 20 or more repeating units repeating units represented by the formula —(CX⁶X⁷CF₂CF₂O)— (wherein X⁶ and X⁷ each independently represents F or H). Such compounds are described in WO2003/022906.

In some embodiments, n and m in formula (II) are not both 1.

Rf¹ which is monovalent to trivalent can be used. In the case where the Rf¹ is monovalent, exemplary terminal groups include (CₙF₂ₙ₊₁)—, (CₙF₂ₙ₊₁O)—, (XCₙF₂ₙO)—, or (XCₙF₂ₙ₊₁)— (wherein X is hydrogen, chlorine, or bromine, and n is an integer of 1 to 10), such as is the case with CF₃O(C₂F₄O)ₚCF₂—, C₃F₇O(CF₂CF₂CF₂O)ₚCF₂CF₂—, C₃F₇O(CF(CF₃)CF₂O)ₚCF(CF₃)—, and F(CF(CF₃)CF₂O)ₚCF(CF₃)—, wherein the average value of p is from 0 to 50, such as 3 to 30, 3 to 20, or 4 to 15.

In the case where Rf¹ is divalent, exemplary groups include —(CF₂O)_{q}(C₂F₄O)ᵣCF₂—, —(CF₂)₃O(C₄F₈O)ᵣ(CF₂)₃—, —CF₂O(C₂F₄O)ᵣCF₂—, —C₂F₄O(C₃F₆O)ᵣC₂F₄—, —CF(CF₃)(OCF₂CF(CF₃))ₛOCₜF₂ₜO(CF(CF₃)CF₂O)ᵣCF(CF₃)—, wherein q, r, and s in the formula are average values from 0 to 50, such as 3 to 30, 3 to 20, or 4 to 15, and t is an integer of 2 to 6. Specific examples or synthesis methods for such compounds are described in WO 2005/113690.

In certain embodiments, the fluorine-containing radiation curable compound is present in the radiation curable composition in an amount ranging from 0.1 to 10 percent by weight, such as from 0.2 to 10, or, in some cases, 0.5 to 6 percent weight, based on the total weight of the radiation curable film-forming composition.

In some embodiments, the radiation curable film-forming composition further comprises inorganic fine particles, such as inorganic oxide particles. In some embodiments, these particles are substantially spherical in shape, relatively uniform in size (have a substantially monodisperse size distribution) or a polymodal distribution obtained by blending two or more substantially monodisperse distributions.

It certain embodiments, the fine particles have an average particle diameter of 1 to 200 nanometers, such as 1 to 100 nanometers, or, in some cases, 2 to 75 nanometers. Average particle size of the colloidal inorganic oxide particles can be measured using transmission electron microscopy, as will be appreciated by those skilled in the art, to count the number of colloidal inorganic oxide particles of a given diameter.

A wide range of inorganic oxide particles can be used, such as silica, titania, alumina, zirconia, vanadia, chromia, iron oxide, antimony oxide, tin oxide, and mixtures thereof. The colloidal inorganic oxide particles can comprise essentially a single oxide such as silica, a combination of oxides, such as silica and aluminum oxide, or a core of an oxide of one type (or a core of a material other than a metal oxide) on which is deposited an oxide of another type.

In certain embodiments, the inorganic particles are provided in the form of a sol (e.g., colloidal dispersions of inorganic particles in liquid media), such as where the liquid media comprises water or, in some cases, the particles are dispersed in a radiation curable compound, such as any of those described earlier. In certain embodiments, the sol contains from 2 to 50 weight percent, such as 25 to 45 weight percent, of colloidal inorganic oxide particles based on the total weight of the sol. Such sols can be prepared by methods well known in the art.

In certain embodiments, the inorganic fine particles are surface treated, such as with a fluorosilane surface treatment, wherein “fluorosilane” refers to a surface treatment agent comprising at least one hydrolyzable or hydrolyzed silane moiety and at least one fluorinated moiety. Additionally, suitable fluorosilane components can be polymers, oligomers, or monomers and often comprise one or more fluorochemical moieties that contain a fluorinated carbon chain having from 3 to 20, such as 6 to 14, carbon atoms. The fluorochemical moiety may be linear, branched, or cyclic or any combination thereof. The fluorochemical moiety is usually free of curable olefinic unsaturation but can optionally contain in-chain heteroatoms such as oxygen, divalent or hexavalent sulfur, or nitrogen. Perfluorinated groups are often used, but hydrogen or halogen atoms can also be present as substituents.

A class of useful fluorosilane surface treatment agents can be represented by the following general formula (VIII):

(S_{y})ᵣ—W—(R_{f})ₛ (VIII)

wherein each S_{y} independently represents a hydrolyzable silane moiety, R_{f} is F or a fluorinate moiety, r is at least 1, such as 1-4; s is at least 1, such as 1-4; and W is a single bond or a linking group.

In certain embodiments, each S_{y} moiety of Formula (VIII) independently is a monovalent or divalent, nonionic hydrolyzable silane moiety that may be linear, branched, or cyclic. As used herein, the term “hydrolyzable silane moiety” with respect to S_{y} refers to a hydrolyzable silane moiety comprising at least one Si atom bonded to at least one halogen atom and/or at least one oxygen atom in which the oxygen atom preferably is a constituent of an acyloxy group and/or an alkoxy group.

Representative specific examples of suitable compounds according to Formula (VIII) include: FSi(OCH₂CH₃)₃, C₅F₁₁CH₂OCH₂CH₂CH₂Si(OCH₂CH₃)₃, C₇F₅CH₂OCH₂CH₂CH₂Si(OCH₂CH₃)₃, C₇F₅CH₂OCH₂CH₂CH₂SiCl₃, C₈F₁₇CH₂CH₂OCH₂CH₂CH₂SiCl₃, C₁₈F₃₇CH₂OCH₂CH₂CH₂CH₂SiCl₃, CF₃CF(CF₂Cl)CF₂CF₂SO₂N(CH₃)CH₂CH₂CH₂SiCl₃, C₈F₁₇SO₂N(CH₂CH₃)CH₂CH₂CH₂Si(OCH₃)₃C₈F₁₇SO₂N(CH₃)CH₂CH₂CH₂Si(OCH₃), C₈F₁₇SO₂N(CH₂CH₃)CH₂CH₂CH₂Si(OCH₃)_{av1.9}[(OCH₂CH₂)_{av6.1}OCH₃]_{av1.1}, C₇F₅CH₂OCH₂)₃Si(OCH₂CH₂OCH₂CH₂OH)₃, C₇F₁₅CH₂CH₂Si(CH₃)Cl₂, C₇H₅CH₂CH₂SiCl₃, C₈F₁₇CH₂CH₂SiCl₃, Cl₃SiCH₂CH₂CH₂OCH₂CF₂(OCF₂CF₂)₈OCF₂CH₂OCH₂CH₂CH₂SiCl₃, CF₃O(CF₂CF(CF₃)₃O)₄CF₂C(═O)NHCH₂CH₂CH₂Si(OC₂H₅)₃, CF₃O(C₃F₆O)₄(CF₂O)₃CF₂CH₂OC(═O)NHCH₂CH₂CH₂Si(OCH₃)₃, Cl₃SiCH₂CH₂OCH₂(CF₂CF₂O)₈(CF₂O)₄CF₂CH₂CH₂CH₂SiCl₃, C₈F₁₇CONHC₆R₄Si(OCH₃)₃, and C₈F₁₇SO₂N (CH₂CH₃)CH₂CH₂CH₂Si(OCH₃)ₐᵥ₁(OCH₂CH₂(OCH₂CH₂)₂OCH₃)ₐᵥ₂.

As will be appreciated, useful fluorosilane components can be prepared, e.g., by reacting: (a) at least one fluorochemical compound having at least one reactive functional group with (b) a functionalized silane having from one to about three hydrolyzable groups and at least one alkyl, aryl, or alkoxyalkyl group that is substituted by at least one functional group that is capable of reacting with the functional group of the fluorochemical compound(s). Such methods are disclosed in U.S. Pat. No. 5,274,159 (Pellerite et al.).

In addition to the previously described components, the transparent radiation curable film-forming composition may further include other optional additives, such as solvents, surfactants, antistatic agents, leveling agents, initiators, photo sensitizers, stabilizers, absorbers, antioxidants, crosslinking agents, fillers, fibers, lubricants, pigments, dyes, plasticizers, suspending agents and the like.

Depending upon the energy source used to cure the transparent radiation-curable composition used in the methods of the present invention, an initiator may be required to generate the free radicals which initiate polymerization. Examples of suitable free radical initiators that generate a free radical source when exposed to thermal energy include, but are not limited to, peroxides such as benzoyl peroxide, azo compounds, benzophenones, and quinones. Examples of photoinitiators that generate a free radical source when exposed to visible light radiation include, but are not limited to, camphorquinones/alkyl amino benzoate mixtures. Examples of photoinitiators that generate a free radical source when exposed to ultraviolet light include, but are not limited to, organic peroxides, azo compounds, quinones, benzophenones, nitroso compounds, acryl halides, hydrozones, mercapto compounds, pyrylium compounds, triacrylimidazoles, bisimidazoles, chloroalkylriazines, benzoin, benzoin methyl ether, benzoin ethyl ether, benzoin isopropyl ether, benzoin isobutyl ethers and methylbenzoin, diketones such as benzil and diacetyl, phenones such as acetophenone, 2,2,2-tri-bromo-1-phenylethanone, 2,2-diethoxyacetophenone, 2,2-dimethoxy-2-phenylacetophenone, 2,2,2,-tribromo-1 (2-nitrophenyl)ethanone, benzophenone, 4,4-bis(dimethyamino)benzophenone, and acyl phosphates. Examples of commercially available ultraviolet photoinitiators include those available under the trade designations IRGACURE 184 (1-hydroxycyclohexyl phenyl ketone), IRGACURE 361 and DAROCUR 1173 (2-hydroxy-2-methyl-1-phenyl-propan-1-one) from Ciba-Geigy. In certain embodiments, the initiator is used in an amount of from 0.1 to 10 percent by weight, such as 1 to 5 percent by weight, based on the total weight of the transparent radiation-curable composition.

In certain embodiments, the transparent radiation-curable composition includes a photosensitizer, which aids in the formation of free radicals, especially in an air atmosphere. Suitable photosensitizers include, but are not limited to, aromatic ketones and tertiary amines Suitable aromatic ketones include, but are not limited to, benzophenone, acetophenone, benzil, benzaldehyde, and o-chlorobenzaldehyde, xanthone, thioxanthone, 9,10-anthraquinone, and many other aromatic ketones. Suitable tertiary amines include, but are not limited to, methyldiethanolamine, ethyldiethanolamine, triethanolamine, phenylmethyl-ethanolamine, dimethylaminoethylbenzoate, and the like. In certain embodiments, the photosensitizer is used in an amount of from 0.01-10 percent by weight, such as 0.05 to 5 percent by weight, based on the total weight of the composition.

Suitable methods for making such transparent radiation-curable compositions are illustrated in the Examples.

As indicated, in the methods of the present invention the transparent radiation-curable composition is applied onto a colored base coat. The colored base coat may be deposited by one or more of a number of methods including spraying, rolling, curtain coating, dipping/immersion, brushing, or flow coating. Usual spray techniques and equipment for air spraying and electrostatic spraying and either manual or automatic methods can be used. The base coat often has a dry film thickness of 2 to 50 microns, often 12 to 25 microns. After forming a film of the colored film-forming composition on the substrate, the base coat layer can be cured or alternatively given a drying step in which solvent is driven out of the coating film by heating or an air drying period before application of the transparent radiation-curable composition. Suitable drying conditions may depend, for example, on the particular coating composition, and on the ambient temperature and humidity.

The transparent radiation-curable film-forming composition may be applied to the base coat using any of the methods described above and cured. The transparent radiation-curable film-forming composition may be applied to the colored film-forming composition wet-on-wet, or the base coat may be dried and/or cured prior to application of the transparent top coat. The dry film thickness of the topcoat may be, for example, 1 to 50 microns, such as 12 to 25 microns.

As will be appreciated, the present invention is also directed to multi-component composite coating comprising a colored coating serving as a base coat and a transparent topcoat over the base coat, wherein the transparent topcoat is a radiation cured composition comprising a fluorine-containing radiation cured compound.

The composite coatings describe herein may be deposited upon any of a variety of substrates, including human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in, for example, U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics

Examples of suitable polymeric substrates are polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine, dicyanodiamide and/or urea/formaldehyde resins.

In certain embodiments, the coating systems of the present invention are suitable for application to “flexible” substrates. As used herein, the term “flexible substrate” refers to a substrate that can undergo mechanical stresses, such as bending or stretching and the like, without significant irreversible change. In certain embodiments, the flexible substrates are compressible substrates. “Compressible substrate” and like terms refer to a substrate capable of undergoing a compressive deformation and returning to substantially the same shape once the compressive deformation has ceased. The term “compressive deformation” and like terms mean a mechanical stress that reduces the volume at least temporarily of a substrate in at least one direction. Examples of flexible substrates includes non-rigid substrates, such as woven and nonwoven fiberglass, woven and nonwoven glass, woven and nonwoven polyester, thermoplastic urethane (TPU), synthetic leather, natural leather, finished natural leather, finished synthetic leather, foam, polymeric bladders filled with air, liquid, and/or plasma, urethane elastomers, synthetic textiles and natural textiles. Examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam As used herein, the term “open cell foam” means that the foam comprises a plurality of interconnected air chambers. As used herein, the term “closed cell foam” means that the foam comprises a series of discrete closed pores. Example foam substrates include but are not limited to polystyrene foams, polyvinyl acetate and/or copolymers, polyvinyl chloride and/or copolymers, poly(meth)acrylimide foams, polyvinylchloride foams, polyurethane foams, and polyolefinic foams and polyolefin blends. Polyolefinic foams include but are not limited to polypropylene foams, polyethylene foams and ethylene vinyl acetate (“EVA”) foams EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. “Textiles” can include natural and/or synthetic textiles such as fabric, vinyl and urethane coated fabrics, mesh, netting, cord, yarn and the like, and can be comprised, for example, of canvas, cotton, polyester, KELVAR, polymer fibers, polyamides such as nylons and the like, polyesters such as polyethylene terephthalate and polybutylene terephthalate and the like, polyolefins such as polyethylene and polypropylene and the like, rayon, polyvinyl polymers such as polyacrylonitrile and the like, other fiber materials, cellulosics materials and the like. In certain embodiments of the present invention, the substrate itself (such as a polymeric substrate) is opaque, i.e., not transparent.

The coating systems of the present invention can, in at least some cases, find particular application in the consumer electronics market. As a result, the present invention is also directed to a consumer electronics device, such as a cell phone, personal digital assistant, smart phone, personal computer, digital camera, or the like, which is at least partially coated with a multi-component composite coating of the present invention.

Illustrating the invention are the following examples, which, however, are not to be considered as limiting the invention to their details. Unless otherwise indicated, all parts and percentages in the following examples, as well as throughout the specification, are by weight.

### EXAMPLES

### Preparation of Silica Nanoparticle Dispersions

Silica nanoparticle dispersions were prepared using the ingredients and the amounts listed in Table 1. To form these dispersions, the silica dispersion was added to a container and agitated using a magnetic stirrer or stirring blade. Next, the trichlorosilane material was added to the dispersion and allowed to stir in an air atmosphere for a minimum of 2 hours at room temperature.

TABLE 1

| Raw material | Example 1 | Example 2 | Example 3 |
|---|---|---|---|
| Silica Dispersion¹ | 100 g | 100 g | 100 g |
| (Heptadecafluoro-1,1,2,2- | | 3.0 g | |
| Tetrahydrodecyl) Trichlorosilane | | | |
| (Tridecafluoro-1,1,2,2- | | | 3.0 g |
| Tetrahydrooctyl)-Trichlorosilane | | | |

¹Dispersion of silica nanoparticles in trimethylolpropane triacrylate.

### Preparation of Clear Coating Compositions

Clear coating compositions were prepared using a basemix formulation having the ingredients and amounts listed in Table 2. Components 1 to 6 were added in order with agitation and mixed until dissolved and homogeneous. Additional viscosity reductions were made with additional GXS61352 if needed.

TABLE 2

| Component | Raw material | Grams |
|---|---|---|
| 1 | RR-U 0606 Urethane Acrylate | 65.8 |
| 2 | Sartomer SR351 | 16.6 |
| 3 | Darocur 1173 | 0.94 |
| 4 | Irgacure 184 | 0.94 |
| 5 | Dowanol PM Acetate | 15.72 |
| 6 | GXS61352 solvent blend | 50 |

¹Polyurethane acrylic co-polymer commercially available from Lidye Chemical Co., Ltd.
²Trimethylolpropane triacrylate commercially available from Sartomer Co.
³Photoinitiator commercially available from Ciba Specialty Chemicals
⁴Photoinitiator commercially available from BASF
⁵Commercially available from Eastman Chemical
⁶Commercially available from PPG Industries, Inc.

Clear coating compositions were prepared using the ingredients and amounts listed in Table 3. To form the coating compositions, the basemix was added to a container and agitated. Next, the remaining components were added to the basemix with agitation and mixed well. The clearcoat compositions were allowed to rest for a minimum of 16 hours (typically overnight) to allow the mixtures to equilibrate.

TABLE 3

| Raw | | | | | | | | | |
|---|---|---|---|---|---|---|---|---|---|
| material | Example 1 | Example 2 | Example 3 | Example 4 | Example 5 | Example 6 | Example 7 | Example 8 | Example 9 |
| CC basemix | 150. g | 150. g | 150. g | 150. g | 150. g | 150. g | 150. g | 150. g | 150. g |
| (Table 2) | | | | | | | | | |
| Dispersion | 20. g | | | | | | | | |
| example 1 | | | | | | | | | |
| (Table 1) | | | | | | | | | |
| Dispersion | | 20. g | | | | 20. g | | | |
| example 2 | | | | | | | | | |
| (Table 1) | | | | | | | | | |
| Dispersion | | | 20. g | | | | 20. g | | |
| example 3 | | | | | | | | | |
| (Table 1) | | | | | | | | | |
| Optool | | | | 1.0 g | | 10.0 g | | | |
| DAC¹ | | | | | | | | | |
| Megaface | | | | | 3.0 g | | 3.0 g | | |
| RS-75E² | | | | | | | | | |
| BYK UV- | | | | | | | | 0.50 g | |
| 3500³ | | | | | | | | | |

¹Commercially available from Daikin Industries, LTD.
²Commercially available from Dainippon Ink Co.
³Commercially available from BYK-Chemie

### Basecoat/Clearcoat Systems

Colored basecoats identified in Table 4 were applied over a PC/ABS test plaque using an Iwata Eclipse airbrush with a target dry film thickness of 12 to 20μ. The basecoat test plaques were either baked or ambient flashed (wet-on-wet) as described in Table 4 prior the clearcoat application. The clearcoat coating compositions described in Table 4 were applied using an Iwata Eclipse airbrush with a target dry film thickness of between 0.6 to 1.0 mils (15 to 25μ). The test plaque was placed in a convection oven for 5-10 minutes at 50-80° C. to accelerate the solvent flash off. Next, the coated part was exposed to UV radiation by exposing the part to a Fusion 600W type H lamp with a target distance of 2-3 inches from the coating surface. The target energy density (sometimes referred to as “dose”) was 0.8 Joules/cm² (800 mJ/cm²), and the target intensity in the UV-A region was 0.5 Watts/cm² (500 mW/cm²).

Surface energy measurements were performed on the test plaques using a Kruss DSA 100 drop shape analyzer along with the associated software. First, a 2 μl drop of deionized water was applied to the test plaque. A minimum of 2 test drops were measured and averaged. Next, a 1-2 μl drop of Squalene was applied to the test plaque and a minimum of 2 test drops were measured and averaged. All individual measurements are made on a virgin area of the test plaque.

Visual observations were made by applying a number of fingerprints (generally between 5 and 10) to the coated surface of each test plaque either by one or more than one person. Samples were compared to one another and ranked accordingly. Easy clean ranking was done by using a soft paper towel such as WYPALL L30 from Kimberly Clark (new piece for each test) and each plaque is rubbed the same to see how easy or hard it is to remove the fingerprint, or make them less noticeable. The fingerprints or smears after cleaning appeared white against the black background. Results are set forth in Table 4.

TABLE 4

| | | | Total | | | | | Visual Fingerprint |
|---|---|---|---|---|---|---|---|---|
| | | | Surface | Dispersive | Polar | Water | Squalene | resistance (FPR) and |
| Clearcoat | | Basecoat bake | energy | Component | Component | Contact | Contact | easy clean (EC) |
| Example | Basecoat | conditions | (mN/m) | (mN/m) | (mN/m) | Angle (°) | Angle (°) | properties |
| Example 5 | Deltron | 10′ @ 80° C. | 13.4 | 11.5 | 1.9 | 107.1 | 76.9 | Improved FPR and EC |
| | DMD1683 | | | | | | | |
| | black | | | | | | | |
| Example 5 | XPB63943 | 10′ @ 80° C. | 13.6 | 11.8 | 1.8 | 107.1 | 75.7 | Improved FPR and EC |
| | black | | | | | | | |
| Example 5 | Deltron | 5′ Ambient flash | 14.2 | 12.4 | 1.9 | 106.3 | 74.0 | Improved FPR and EC |
| | DMD1683 | | | | | | | |
| | black | | | | | | | |
| Example 5 | XPB63943 | 5′ Ambient flash | 13.6 | 11.8 | 1.8 | 107.1 | 75.7 | Improved FPR and EC |
| | black | | | | | | | |
| Example 8 | XPB63943 | 10′ @ 80° C. | 24.2 | 22.3 | 1.9 | 97.0 | 44.6 | Poor FPR and EC |
| | black | | | | | | | |

Deltron DMD1683 Black thermoplastic basecoat commercially available from PPG Industries, Inc.
XPB63943 Black thermoplastic basecoat commercially available from PPG Industries, Inc.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of forming a multi-component composite coating on a substrate, comprising applying a transparent radiation curable film-forming composition onto a colored base coat deposited upon a substrate to form a transparent top coat over the basecoat, wherein:
(a) the colored base coat comprises:
(i) a colorant, and
(ii) a film-forming resin, and
(b) the transparent radiation curable film-forming composition comprises a fluorine-containing radiation curable compound.

2. The method of claim 1, wherein the base coat further comprises a cellulose ester.

3. The method of claim 1, wherein the basecoat further comprises a silicone.

4. The method of claim 1, wherein the basecoat is opaque.

5. The method of claim 1, wherein the transparent radiation curable film-forming composition comprises a radiation-curable compound comprising polyurethane (meth)acrylate.

6. The method of claim 1, wherein the fluorine-containing radiation curable compound is represented by the general formula:
(R_{A})ₓ—W—(R_{f})_{y}
wherein:
(i) each R_{A} independently represents a radiation curable moiety;
(ii) each R_{f} independently represents a fluorinated moiety;
(iii) x is at least 2;
(iv) y is at least 1; and
(v) W is a group linking R_{A} and R_{f}.

7. The method of claim 1, wherein the fluorine-containing radiation curable compound comprises a perfluoro-type polymer.

8. The method of claim 1, wherein the fluorine-containing radiation curable compound comprises a perfluoropolyether and one or more polymerizable unsaturated groups per molecule.

9. The method of claim 8, wherein the fluorine-containing radiation curable compound is represented by the general structure: 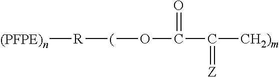
in which:
(a) PFPE is a perfluoropolyether;
(b) each n and m is independently 1 or 2;
(c) R is a linking group; and
(d) Z is H or CH₃.

10. The method of claim 9, wherein m+n=3.

11. The method of claim 9, wherein R comprises one or more urethane linkages.

12. The method of claim 1, wherein the transparent radiation curable film-forming composition further comprises inorganic particles.

13. The method of claim 12, wherein the inorganic particles comprise inorganic oxide particles.

14. The method of claim 13, wherein the inorganic oxide particles comprise silica.

15. The method of claim 12, wherein the inorganic particles are surface treated with a fluoro silane.

16. The method of claim 15, wherein the fluorosilane is represented by the following general formula:
(S_{y})ᵣ—W—(R_{f})ₛ
wherein: (a) each S_{y} independently represents a hydrolyzable silane moiety; (b) R_{f} is F or a fluorinate moiety, (c) r is at least 1; (d) s is at least 1; and (e) W is a single bond or a linking group.

17. The method of claim 1, wherein the transparent radiation-curable film-forming composition is applied to the colored film-forming composition wet-on-wet.

18. A multi-component composite coating:
(a) a colored coating serving as a base coat; and
(b) a transparent topcoat over the base coat, wherein the transparent topcoat is a radiation cured composition comprising a fluorine-containing radiation cured compound.
